(19) United States
(12) Patent Application Publication
(10) Pub. No.: US 2014/0344339 A1
(43) Pub. Date: Nov. 20, 2014

(54) SYSTEM FOR PROVIDING PERSONAL INFORMATION USING CLOUD ID CARD AND METHOD THEREOF

(71) Applicant: ELECTRONICS AND TELECOMMUNICATIONS RESEARCH INSTITUTE, Daejeon (KR)

(72) Inventors: Soo-Hyung KIM, Daejeon (KR); Young-Seob CHO, Daejeon (KR); Jong-Hyouk NOH, Daejeon (KR); Sang-Rae CHO, Daejeon (KR); Jin-Man CHO, Daejeon (KR); Dae-Seon CHOI, Daejeon (KR); Seung-Hyun KIM, Daejeon (KR); Seok-Hyun KIM, Daejeon (KR); Seung-Hun JIN, Daejeon (KR)

(73) Assignee: ELECTRONICS AND TELECOMMUNICATIONS RESEARCH INSTITUTE, Daejeon (KR)

(21) Appl. No.: 14/277,190

(22) Filed: May 14, 2014

(30) Foreign Application Priority Data
May 16, 2013 (KR) 10-2013-0055877

(51) Int. Cl. H04L 29/06

(52) U.S. Cl. CPC H04L 67/42
USPC 709/203

(57) ABSTRACT

Disclosed are a system and a method for providing personal information using a cloud ID card. A system for providing personal information in accordance with the present invention includes: a cloud ID server configured to store user's personal information and cloud ID information for using the user's personal information; a cloud ID card configured to store the cloud ID information provided from the cloud ID server; and a service terminal configured to obtain the cloud ID information from the cloud ID card and to be provided with the user's personal information from the cloud ID server by use of the obtained cloud ID information. When the cloud ID information is provided from the service terminal, the cloud ID server confirms consent to use of the personal information from a user terminal corresponding to the provided cloud ID information and provides the confirmed personal information to the service terminal.

### CROSS-REFERENCE TO RELATED APPLICATIONS

This application claims the benefit of Korean Patent Application No. 10-2013-0055877, filed with the Korean Intellectual Property Office on May 16, 2013, the disclosure of which is incorporated herein by reference in its entirety.

### BACKGROUND

1. Technical Field

The present invention relates to a method of providing personal information, especially to a system and a method for providing personal information using a cloud ID card which allow a service terminal to be provided with the personal information managed by a cloud server in a cloud environment by employing a cloud ID card including a unique identity information assigned to each user, but only after performing a consent procedure to use of the personal information.

2. Background Art

Recently, security measures for addressing personal information security have been sought, as the leakage of personal information collected in an offline service environments, such as rental shops, agencies, hospitals, other PCs, POS terminals, and smart terminal for recruiting subscribers, has become a serious social issue. The general measures in the current level of technology include encrypting personal information data through a software or hardware device, implementing an access control for personal information, managing the history of using personal information, and installing a vaccine program as a system security device.

However, in the offline service environments that are run mostly by small enterprises that have no or little security-related technical knowledge, the effect of such technology is very minimal. This is because, in these environments, it is difficult to manage the passwords, prone to attack to the terminals, and easy to have the terminals, which have stored personal information therein, to those of malicious intention due to frequent business shut-down or change of terminals.

Moreover, as societies become increasingly sophisticated, there are growing attempts for automating offline services. For example, electronic passports allow the personal information required for emigration and immigration procedures to be stored in and read from the safe IC card, thus enabling an automated entry and departure inspection, and the adult verification IC card such as the Taspo Card in Japan enables automated adult verification while resolving the counterfeiting issue of plastic certificates.

However, the simple IC card based technology has the following issues. The first issue is security; it is not easy to discard a lost card and is difficult to verify whether the card belong to the person presenting the card. Secondly, the information is fixed. That it, the personal information stored in the IC card can be hardly updated and thus is only suitable for managing special-purpose personal information, such as the passport number, finger print, etc., or invariable personal information, such as the name, birthday, etc. Thirdly, it is impossible for the user to find out where and how the provided information is stored and used or whether or not old personal information, such as telephone number, address, etc., is still registered. Fourthly, the conventional IC card provides simple personal information only and thus is not able to provide a connection for linking with various online services.

Furthermore, the growing smart environments mandate the services in the offline environment to require more personal information. However, most of the personal information is still inputted manually by the user. The manual input is prone to input errors and takes a long time, making it impractical to receive an ample amount of information from the user unless it is for services such as financial/medical/communication services in which it is inevitable for the user to input the information.

In addition, since there are inadequate ways for checking whether or not other person's personal information is maliciously inputted instead of legitimately inputted personal information, some personal information, such as the name, birthday, etc., can be verified only through an accredited-real-name certificate, such as the Resident Registration Card or the Driver's License. Moreover, since such a real-name certificate having the personal information printed on a plastic card can be easily counterfeited, juveniles are even counterfeiting the accredited real-name certificate.

### SUMMARY

Therefore, to resolve the conventional technical problem, the purpose of the present invention is to provide a system for providing personal information using cloud ID card and a method thereof which has a service terminal configured to be provided the personal information managed in a cloud server in a cloud environment by employing a cloud ID card which including a unique identity information given to each user but not provided until performing the consent to use of personal information.

However, the goals of the present invention shall by no means restrict the present descriptions and the other goals not described shall be clearly understood by the following descriptions.

A system for providing personal information in accordance with an aspect of the present invention to achieve the goals includes: a cloud ID server configured to store user's personal information and cloud ID information for using the user's personal information; a cloud ID card configured to store the cloud ID information provided from the cloud ID server; and a service terminal configured to obtain the cloud ID information from the cloud ID card and be provided the user's personal information from the cloud ID server by use of the obtained cloud ID information. The cloud ID server, when provided with the cloud ID information from the service terminal, is configured to confirm the consent to use of the personal information from a user terminal corresponding to the provided cloud ID information and to provide the confirmed personal information to the service terminal.

In one embodiment, the cloud ID server is configured to register and manage information about the user terminal used by a user and the cloud ID card which is to be used by the user, and to provide the cloud ID information to the cloud ID card through the registered user terminal.

In one embodiment, the cloud ID server is configured to provide the personal information and information of consent to use of the personal information to retrieve the personal information to the service terminal, and the information of consent to use of the personal information enables some or all of the personal information to be retrieved without the user's consent to use.

In one embodiment, the cloud ID server is configured to provide some or all of the user's personal information corresponding to the provided information of consent to use of the personal information to the service terminal when provided with the information of consent to use of the personal information from the service terminal.

In one embodiment, the service terminal is configured to obtain the pre-stored cloud ID information from the cloud ID card through short distance wireless communication technology.

Another aspect of the present invention features a system for providing personal information that includes: a communication portion configured to transmit diverse information by interoperating with the cloud ID server therewith which stores user's personal information; an input portion configured to receive an input according to user's manipulation to use the personal information; a short distance communication module configured to obtain cloud ID information from a cloud ID card according to the information input from a user; a control portion configured to request the user's personal information to the cloud ID server by use of the obtained cloud ID information and be provided the user's personal information thereto as a response to it; and a display portion configured to display a part or whole of the user's provided personal information in a screen.

In one embodiment, the control portion is configured to be provided with the user's personal information thereto from the cloud ID server by use of the obtained cloud ID information but only after confirming the consent to use of the user's personal information from the service terminal corresponding to the cloud ID information by the cloud ID server.

In one embodiment, the control portion is configured to be provided with the personal information and information of consent to use of the personal information to retrieve the personal information, and the information of consent to use of the personal information enables some or all of the personal information to be retrieved without the user's consent to use.

In one embodiment, the control portion is configured to provide the information of consent to use of the personal information to the cloud ID server, and to be provided with some or all of the user's personal information corresponding to the provided information of consent to use of the personal information from the cloud ID server.

In one embodiment, the user terminal is configured to confirm the consent to use of providing the user's personal information to the service terminal, by use of one of clicking a consent button on the screen, inputting predetermined authentication information, or touching the cloud ID card.

Yet another aspect of the present invention features a method for providing personal information that includes: obtaining pre-stored cloud ID information by a service terminal from a cloud ID card a user uses; transferring the cloud ID information obtained by the service terminal to a cloud ID server; and providing user's personal information corresponding to the provided cloud ID information when the cloud ID server is provided with the cloud ID information from the service terminal. In the step of providing the user's personal information, the consent to use of the personal information is confirmed from a user terminal corresponding to the provided cloud ID information when provided with the cloud ID information from the service terminal, and the confirmed personal information is provided to the service terminal.

Moreover, the method further includes creating the cloud ID information by the cloud ID server and transferring the created cloud ID information to the cloud ID card through a user terminal that a user uses.

In one embodiment, in the step of providing the user's personal information, the personal information and information of consent to use of the personal information for retrieving the personal information are provided to the service terminal, and the information of consent to use of personal information enables some or all of the personal information to be retrieved without the user's consent to use.

In one embodiment, in the step of providing the user's personal information, some or all of the user's personal information corresponding to the provided information of consent to use of the personal information is provided when the cloud ID server is provided with the information of consent to use of the personal information from the cloud ID server.

In one embodiment, in the step of obtaining the pre-stored cloud ID information, the service terminal obtains the pre-stored cloud ID information from the cloud ID card through short distance wireless communication technology.

In one embodiment, in the step of providing the user's personal information, the consent to use for providing the user's personal information is confirmed by the user terminal by using one of clicking a consent button on a screen, inputting predetermined authentication information, or touching the cloud ID card.

Still another aspect of the present invention features a method for providing personal information that includes: obtaining cloud ID information from a cloud ID card according to a user's input information; requesting the user's personal information to the cloud ID server by use of the obtained cloud ID information and being provided with the user's personal information as a response; and displaying some or all of the user's provided personal information on a screen.

In one embodiment, in the step of being provided with the user's personal information, the user's personal information is provided from the cloud ID server by use of the obtained cloud ID information but only after the consent to use of the user's personal information is confirmed by the cloud ID server from the service terminal corresponding to the cloud ID information.

In one embodiment, in the step of being provided with the user's personal information, the personal information and information of consent to use of the personal information for retrieving the personal information are provided from the cloud ID server, and the information of consent to use of the personal information enables some or all of the personal information to be retrieved without the user's consent to use.

In one embodiment, in the step of being provided with the user's personal information, the information of consent to use of the personal information is provided to the cloud ID server, and some or all of the user's personal information corresponding to the provided information of consent to use of the personal information is provided from the cloud ID server.

Accordingly, the present invention can provide a better security, thanks to user authentication using two devices, by allowing the service terminal to be provided with personal information, but only after performing the consent to use of the personal information, which is managed by a cloud server in a cloud environment by employing a cloud ID card that includes unique identity information given to each user.

Moreover, the present invention can make the personal information more reliable because the personal information of a user can be always managed to be up-to-date in a cloud environment.

The present invention can also provide a better controllability of personal information because permission to access some or all of the personal information of the user managed by a cloud server in a cloud environment can be changed as necessary.

Furthermore, since the personal information managed by a cloud server in a cloud environment is provided to the service terminal, the present invention can provide various online services linked with the server.

### BRIEF DESCRIPTION OF THE DRAWINGS

FIG. 1 presents a system for providing personal information in accordance with an embodiment of the present invention.

FIG. 2 presents a process of storing cloud ID information in accordance with an embodiment of the present invention.

FIG. 3 presents a process of providing user's personal information in accordance with an embodiment of the present invention.

FIG. 4 presents a process of receiving an input of user's consent in accordance with an embodiment of the present invention.

FIGS. 5a to 5c present screenshots of receiving an input of user's consent in accordance with an embodiment of the present invention.

FIG. 6 presents a process of providing user's personal information in accordance with an embodiment of the present invention.

FIG. 7 presents a detailed configuration of a service terminal in accordance with an embodiment of the present invention.

### DETAILED DESCRIPTION

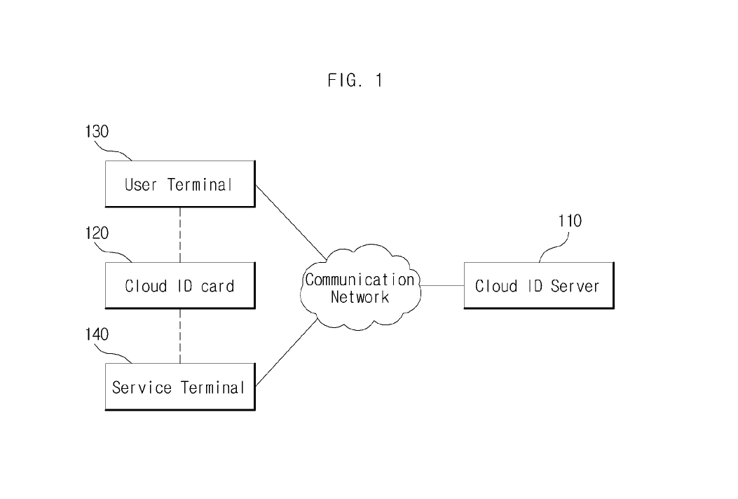

Hereinafter, a system for providing personal information by employing a cloud ID card and a method thereof in accordance with an embodiment of the present invention will be described with reference to FIG. 1 to FIG. 7. A detail explanation focused on understanding actions and interactions in accordance with the present invention will be followed

Also to describe the components of the present invention, different symbols for a same component can be used in different drawings and same symbols can be used in different drawings. However it does not mean a certain component acts differently in accordance with an embodiment nor the different components have a same function in different embodiments thus the functions of each component must be understood by the description about the component of the embodiment.

Particularly the present invention suggests a new way of providing personal information that a service terminal is provided with personal information managed in a cloud server in a cloud environment by employing a cloud ID card which includes unique identity information given to each user, but not provided until performing the consent to use of personal information.

FIG. 1 presents a system for providing personal information in accordance with an embodiment of the present invention.

As shown in FIG. 1, a system in accordance of the present invention for managing personal information may include a cloud ID server 110, a cloud ID card 120, a user terminal 130, and a service terminal 140.

The cloud ID server 110 can manage personal information for each user. Here personal information can include a passport number, a finger print, a name, a birthday, a phone number, an address, and the like. This personal information can be categorized as identification verification information or adult verification information, contact information, financial information, medical information, and the like according to purposes or uses.

The cloud ID server 110 can provide user's personal information according to a request from a service terminal. Especially, the cloud ID server 110, when requested user's personal information from the service terminal 140, is confirmed consent to use of the personal information from the service terminal 140, then provide the user's personal information to the user terminal 130.

A user can preset use scope of personal information without permitting to use all the personal information. For example, the type of personal information to be permitted to use, usable period, usable time and the like can be preset by a user.

The cloud ID server 110 can generate cloud ID information for use of user's personal information and provide the generated cloud ID information to the cloud ID card. The cloud ID card 120 can store the cloud ID information to be used for requesting personal information, which is managed in the cloud ID server 110. The cloud ID card 120 can be embedded in the user terminal for example, a USIM card, an embedded chip, a SD card and so on. In another embodiment, it can be implemented as a separate module such as IC card type.

Here, the cloud ID information can include unique identification information given by the cloud ID server 110 to each user for a cloud ID card, or the cloud ID server's service address and unique identification information for uniquely distinguishing the user information from the service address.

Also the cloud ID information can be generated by the cloud ID server differently to each service terminal or user terminal which manages use of cloud ID for service terminals with a purpose of privacy protection or access control. The cloud ID information created as this way will not be able to specify the user when it is leaked.

Also, the cloud ID information can include one-time identification information for identifying the leaked service terminal. That is, the cloud ID server can create the cloud ID information and transfer it to the cloud ID card through the user terminal.

Also, the cloud ID information can encrypt the identification information for the user terminal or the service terminal or information created by use of a seed value pre-stored in the cloud ID card or a random number using pre-stored security key and include the encrypted value. Here, the security key used to create the cloud ID information can be pre-stored and managed in the cloud ID server and the cloud ID card each. Software for providing cloud ID information can be installed in the cloud ID card 120 and a security key can be pre-stored in a memory accessible by the software.

The user terminal 130 control use of cloud ID. It can control the use of the user's personal information by giving consent or refuse to the use according to the request of a part or whole use of the user's personal information by the service terminal 140.

The service terminal 140 is a terminal that uses the registered user's cloud ID. It can obtain the cloud ID information from the cloud ID card and transfer it or information created using the cloud ID information to the cloud ID server. The service terminal 140 can receive the user's personal information from the cloud ID server, determines whether or not to provide service based on received the personal information, and provide it based on the determination result.

The service terminal 140 can obtain the cloud ID information by short distance wireless communication such as NFC (Near Field Communication), Bluetooth, Zigbee, RFID (Radio Frequency Identification), and Wi-Fi (Wireless Fidelity).

The service terminal 140 can receive information of consent to use of the personal information from the cloud ID server and store and manage it. That is, the service terminal 140 can be provided with the user's personal information when needed by transferring the pre-stored information of consent to use of the personal information to the cloud ID server.

The information of consent to use of the personal information represents information that is needed for a service terminal to use user's personal information 1 registered in the cloud ID server. The information of consent to use of personal information can be created by the cloud ID server based on the user's consent and be provided to the service terminal.

For example, the service terminal 140 can retrieve the personal information without repeating the consent from the user by use of the information of consent to use of personal information within use period, use time, and/or use scope personal information scope, which are set by the user.

Here, the information of consent to use of personal information is for retrieving the personal information. It can include unique identification information given by the cloud ID server 110 to each user, the cloud ID server's service address and user's identification information within the cloud ID server, or identification information or authentication information for the service terminal or the user terminal.

Especially, the authentication information for the service terminal or the user terminal includes unique software or hardware characteristic information of the service terminal, ID/password and/or authentication information of an entity that manages the service terminal, information encrypted by the security key which the service terminal and the cloud ID server share, and information encrypted by the security key which the cloud ID server and cloud ID card share at the time when the user consent is obtained.

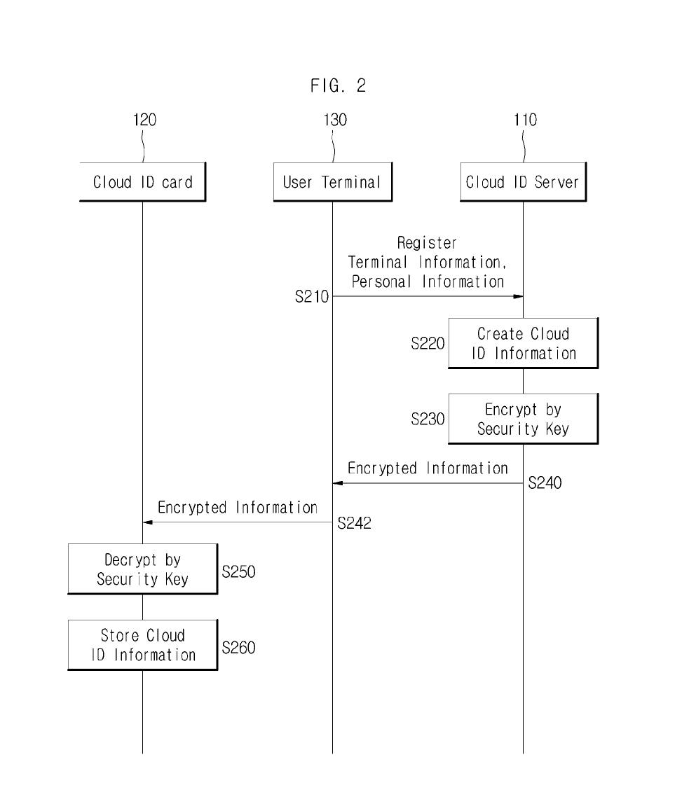

FIG. 2 presents a process of storing cloud ID information in accordance with an embodiment of the present invention.

As shown in FIG. 2, a user terminal in accordance with the present invention can connect to a cloud ID server and register terminal information and personal information in the connected cloud ID server (S210).

Next, the cloud ID server can create cloud ID information necessary to use the registered user's personal information (S220).

Next, the cloud ID server can encrypt the cloud ID information, necessary information for creating the cloud ID information, user's authentication information, and the like with a security key (S230).

Next, the cloud ID server can provide the information encrypted based on the registered terminal information to the user terminal (S240).

Next, when the user terminal is provided with the encrypted information, it transfers it to the cloud ID card (S242).

Next, the cloud ID card can extract the cloud ID information by decrypting the transferred information by a pre-stored security key (S250) and store the extracted cloud ID information (S260).

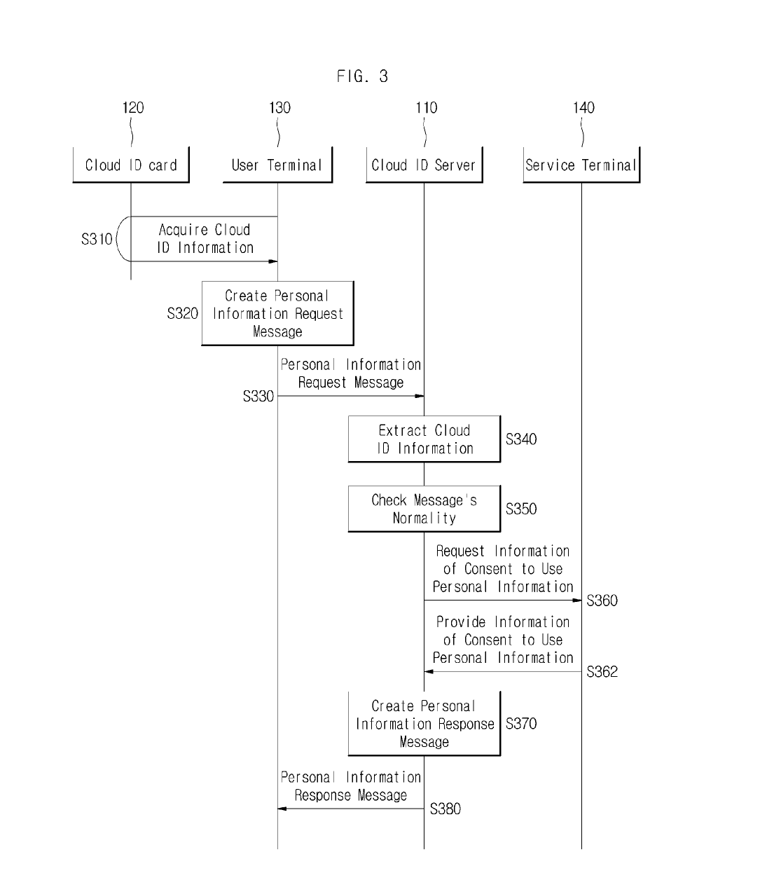

FIG. 3 presents a process for providing user's personal information in accordance with an embodiment of the present invention.

As shown in FIG. 3 a service terminal in accordance with the present invention can obtain cloud ID information from a cloud ID card using short distance wireless communication (S310).

Next, the service terminal can create a personal information request message including the obtained cloud ID information (S320) and transfer the created personal information request message to the cloud ID server (S330).

Next, when the cloud ID server receives the personal information request message, it extracts the cloud ID information from it (S340) and check whether or not the message requesting personal information is normal with the extracted cloud ID information (S350).

Next, the cloud ID server can request information of consent to use of personal information to a user terminal (S360).

Next, the user terminal can provide the information of consent to use of personal information which represents consent or refuse to use (S362).

Next, when the cloud ID server is provided with the information of consent to use of personal information, it creates a personal information response message including a part or whole use of the user's personal information according to the received information of consent to use of personal information (S370) and provide the created personal information response message to the service terminal (S380).

Here, the cloud ID server can create the personal information response message including the information of consent to use of personal information in order to use the personal information without the user's consent for a certain period as well as the user's personal information and provide the created personal information response message to the service terminal.

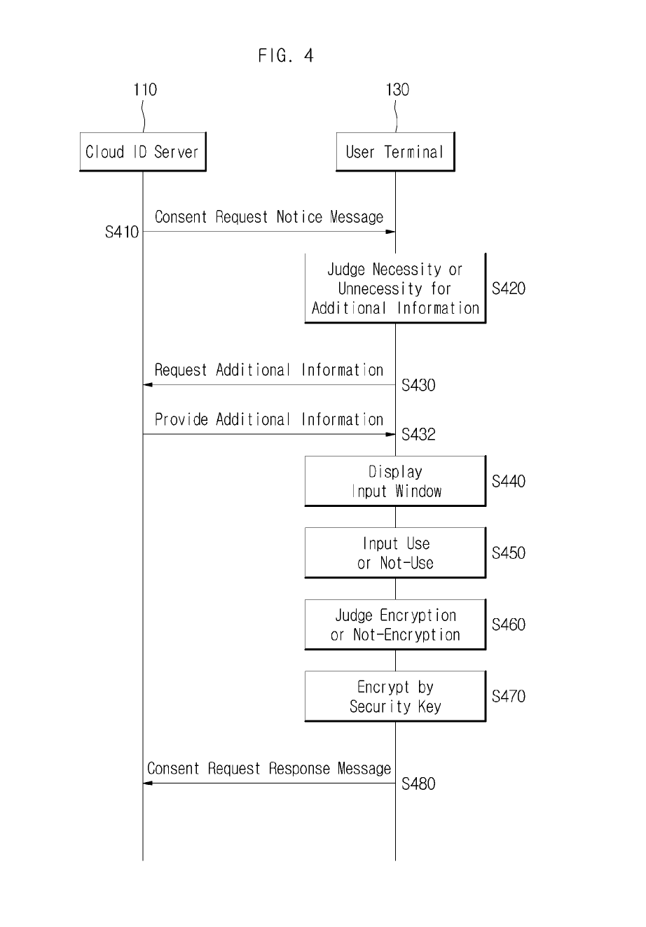

FIG. 4 presents a process of receiving an input of user's consent opinion in accordance with an embodiment of the present invention.

As shown in FIG. 4, a cloud ID server in accordance with the present invention can transfer a consent request notice message for requesting information of consent to use of personal information to a user terminal (S410).

Here, the cloud ID server can transfer the consent request notice message to the user terminal through a service such as a push service or a mobile service similar to a push service. For example, when the user terminal receives the message, a certain application program is executed to display the message

Next, when the user terminal receives the consent request notice message, the user terminal can determine whether or not additional information, such as information on a managing entity of the user terminal or the service terminal, personal information item or third party information is need for the received consent request notice message (S420).

Here, if the user terminal is determined to need additional information, it can request the additional information to the cloud ID server based on identification information in the consent request notice message (S430) and be provided with the additional information from the cloud ID server (S432).

Whereas if the user terminal determines not to need additional information, it can display a window for having an input for a consent to use of personal information for example, consent to use or refuse to use (S440).

Next, the user terminal can receive an input from the user about the consent through the window (S450).

Next, the user terminal can determine whether or not an encryption for the consent is needed (S460). The user can predetermine whether to encrypt the consent or not.

Next, the user terminal can encrypt the consent input from the user by a security key when it is determined that the encryption is needed (S470) and provide the encrypted information to the cloud ID server (S480).

Whereas the user terminal can provide the consent input from the user to the cloud ID server without the encryption when it is determined that the encryption is not needed (S480).

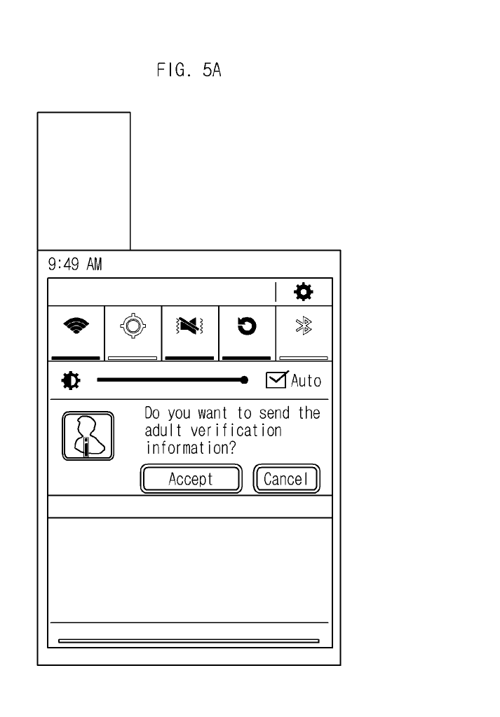

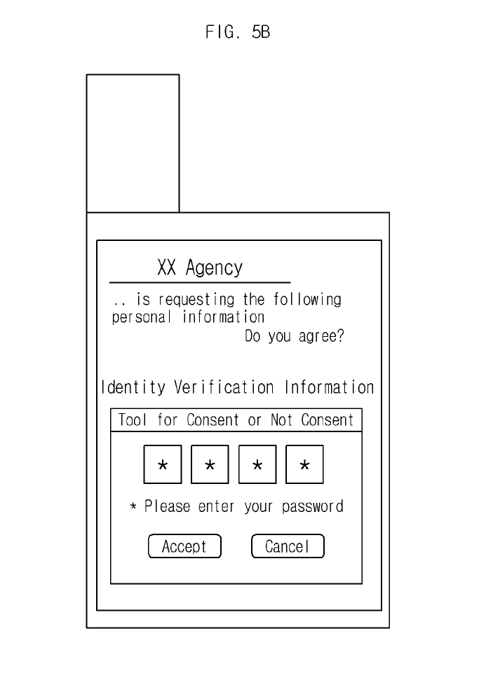

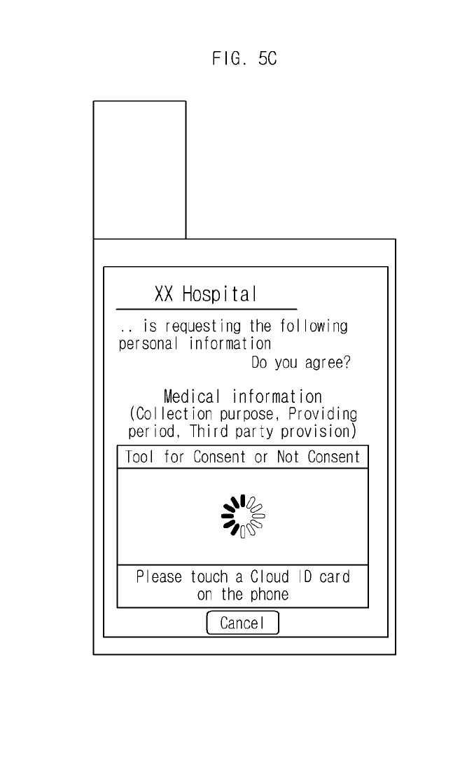

FIGS. 5a to 5c presents screenshots of receiving an input of user's consent opinion in accordance with an embodiment of the present invention.

As in FIG. 5a, the user terminal shows a screen to receive an input from a user about whether or not providing adult verification information when the user is requested to provide adult verification in a place such as an adult product vending machine and a convenient store.

For example, it is realized that user should input the consent by clicking the accept button.

With reference to FIG. 5b, the user terminal shows a screen to receive an input from a user about whether or not providing identification verification when the user is requested to provide the identification verification in the place such as off-line agencies.

For example, it is realized that user should input a predetermined PIN (personal information number).

With reference to FIG. 5c, a user terminal shows a input screen to receive an input from a user about whether or not providing medical information, when the user is requested to provide a purpose of information collection, usable period, acceptance for providing to a third party, and the like, in the place such as hospitals.

For example, it is realized that user can touch the cloud ID card to the service terminal.

When the usable period is defined, it is expected that the information of consent to use of personal information is issued on the hospital terminal so it can use the user's medical information when needed.

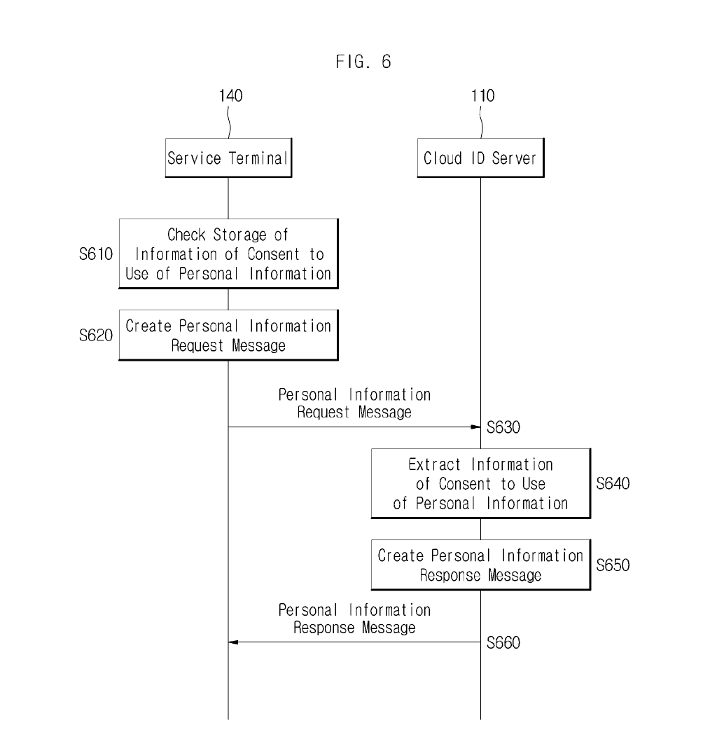

FIG. 6 presents a process of providing user's personal information in accordance with an embodiment of the present invention.

As in FIG. 6, the service terminal in accordance with the present invention can check if the information of consent to use of personal information is stored therein when it needs the user's personal information (S610).

Next, the service terminal can create a personal information request message including the information of consent to use of personal information when the information of consent to use of personal information is stored therein as a result of the check (S620) and transfer the created personal information request message to the cloud ID server (S630).

Next, the cloud ID server can extract the information of consent to use of personal information from the received personal information request message when it receives it (S640).

Next, the cloud ID server can generate a personal information response message including some or all of the pre-stored user's personal information based on the extracted information of consent to use of personal information (S650) and provide the generated personal information response message to the service terminal (S660).

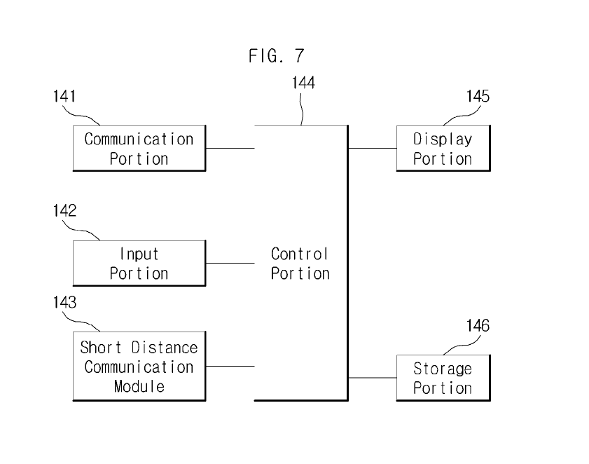

FIG. 7 presents a detail configuration of a service terminal in accordance with an embodiment of the present invention.

As in FIG. 7, the service terminal 140 in accordance with the present invention can include a communication portion 141, an input portion 142, a short distance communication module 143, a control portion 144, a display portion 145, and a storage portion 146.

The communication portion 141 can request and be provided with user's personal information by interoperating with a cloud ID server therewith through wired communication or wireless communication to the cloud ID server.

The input portion 142 can receive an input from the user by a menu or a key manipulation.

The short distance communication module 143 can obtain cloud ID information from a cloud ID card through short distance wireless communication technology.

The control portion 144 can activate an application for using the user's personal information according to the user's input, obtain the cloud ID information from the user's cloud ID card through the activated application, generate a personal information request message including the obtained cloud ID information, and transfer it to the cloud ID server thereby requesting the user's personal information.

The control portion 144 can receive a personal information response message from the cloud ID server as a response to the personal information request message thereof and extract the user's personal information or information of consent to use of personal information from the received personal information response message therein.

The display portion 145 can display the user's personal information through the activated application.

The storage portion 146 can store the application and the information of consent to use of personal information.

Whereas, in the present embodiment described so far, the invention has all the components combined to one, or combined and operated, but is not limited to the present embodiment. That is, as long as not distracting the original intention of the present invention, any component can be selected to combine to operate. In addition, all components can be realized as an individual independent hardware, but also part of or all components can be selected to constitute to a computer program module which performs part of or entire functions which produced by one or a combination of a plurality of hardware. Also, a computer program described above can realize the embodiment of this present invention by being saved in computer readable media that a computer can read such as USB memory device, CD disc, flash memory, and being read and executed by a computer. The computer readable media also can be magnetic recording media, optical recording media, and carrier wave media.

The described embodiments so far is only an example of technical ideas of this present invention, so various permutations, modification, or replacement are possible for people who work in the technical area of the present invention as long as not distracting the original intention of the present invention. Therefore the embodiment disclosed in the present invention and the attached diagrams are not for restricting the technical ideas of the present invention but for explaining and the technical ideas of the present invention are not to be restricted by the embodiment and the attached diagrams. The protected scope of the present invention shall be understood by the scope of claims below, and all technical ideas which reside in the scope of claims shall be included in the rights of the present invention.

What is claimed is:

1. A system for providing personal information, comprising:
a cloud ID server configured to store a user's personal information and cloud ID information for using the user's personal information;
a cloud ID card configured to store the cloud ID information provided from the cloud ID server; and
a service terminal configured to obtain the cloud ID information from the cloud ID card and to be provided with the user's personal information from the cloud ID server by use of the obtained cloud ID information,
wherein the cloud ID server is configured to have consent to use of the personal information confirmed by a user terminal corresponding to the provided cloud ID information when the cloud ID information is provided from the service terminal, and to provide the confirmed personal information to the service terminal.

2. The system of claim 1, wherein the cloud ID server is configured to register and manage information about the user terminal used by a user and the cloud ID card to be used by the user, and to transfer the cloud ID information to the cloud ID card through the registered user terminal.

3. The system of claim 1, wherein the cloud ID server is configured to provide the personal information and information of consent to use of the personal information for retrieving the personal information to the service terminal, and the information of consent to use of the personal information enables some or all of the personal information to be retrieved without the user's consent to use.

4. The system of claim 3, wherein the cloud ID server is configured to provide some or all of the user's personal information corresponding to the provided information of consent to use of the personal information to the service terminal when the information of consent to use of the personal information is provided from the service terminal.

5. The system of claim 1, wherein the service terminal is configured to obtain pre-stored cloud ID information from the cloud ID card through short distance wireless communication technology.

6. The system of claim 1, wherein the user terminal is configured to confirm consent to use of providing the user's personal information with the service terminal by using one of clicking a consent button on a screen, inputting predetermined authentication information, or touching the cloud ID card.

7. A system for providing personal information, comprising:
a communication portion configured to transmit and receive various information by interoperating with a cloud ID server storing a user's personal information;
an input portion configured to receive an input according operation of the user attempting to use the personal information;
a short distance communication module configured to obtain cloud ID information from a cloud ID card according to the information inputted by the user;
a control portion configured to request the user's personal information to the cloud ID server by use of the obtained cloud ID information and to be provided with the user's personal information as a response; and
a display portion configured to display some or all of the user's provided personal information on a screen.

8. The system of claim 7, wherein the control portion is configured to be provided with the user's personal information from the cloud ID server by use of the obtained cloud ID information and the user's personal information is provided after consent to use of the user's personal information from the service terminal corresponding to the cloud ID information is confirmed by the cloud ID server.

9. The system of claim 7, wherein the control portion is configured to be provided with the personal information and information of consent to use of the personal information for retrieving the personal information from the cloud ID server, and the information of consent to use of the personal information enables some or all of the personal information to be retrieved without the user's consent to use.

10. The system of claim 9, wherein the control portion is configured to provide the information of consent to use of the personal information to the cloud ID server, and to be provided with some or all of the user's personal information corresponding to the provided information of consent to use of the personal information from the cloud ID server.

11. A method for providing personal information, comprising:
obtaining pre-stored cloud ID information by a service terminal from a cloud ID card to be used by a user;
transmitting the cloud ID information obtained by the service terminal to a cloud ID server; and
providing the user's personal information corresponding to the provided cloud ID information when the cloud ID server is provided with the cloud ID information from the service terminal,
wherein in the step of providing the user's person information, consent to use of the personal information is confirmed from a user terminal corresponding to the cloud ID information when the cloud ID information is provided from the service terminal, and the confirmed personal information is provided to the service terminal.

12. The method of claim 11, further comprising creating the cloud ID information by the cloud ID server and transferring the created cloud ID information to the cloud ID card through the user terminal that a user uses.

13. The method of claim 11, wherein in the step of providing the user's personal information, the personal information and information of consent to use of the personal information for retrieving the personal information is provided to the service terminal, and the information of consent to use of the personal information enables some or all of the personal information to be retrieved without the user's consent to use.

14. The method of claim 13, wherein in the step of providing the user's personal information, some or all of the user's personal information corresponding to the provided information of consent to use of the personal information is provided to the service terminal when the cloud ID server is provided with the information of consent to use of the personal information from the service terminal.

15. The method of claim 11, wherein in the step of obtaining the pre-stored cloud ID information, the service terminal is configured to obtain the pre-stored cloud ID information from the cloud ID card through short distance wireless communication technology.

16. The method of claim 11, wherein in the step of providing the user's personal information, the consent to use of providing the user's personal information is confirmed from the user terminal by using one of clicking a consent button on a screen, inputting predetermined authentication information, or touching the cloud ID card.

17. A method for providing personal information, comprising:
obtaining cloud ID information from a cloud ID card according to a user's input information;
requesting the cloud ID server for the user's personal information by use of the obtained cloud ID information and being provided with the user's personal information as a response; and
displaying some or all of the user's provided personal information on a screen.

18. The method of claim 17, wherein in the step of being provided with the user's personal information, the user's personal information is provided from the cloud ID server by use of the obtained cloud ID information and the user's personal information is provided after consent to use of the user's personal information from the service terminal corresponding to the cloud ID information is confirmed by the cloud ID server.

19. The method of claim 17, wherein in the step of being provided with the user's personal information, the personal information and information of consent to use of the personal information for retrieving the personal information are provided by the cloud ID server, and the information of consent to use of the personal information enables some or all of the personal information to be retrieved without the user's consent to use.

20. The method of claim 19, wherein in the step of being provided with the user's personal information, the information of consent to use of the personal information is provided to the cloud ID server, and some or all of the user's personal information corresponding to the provided information of consent to use of the personal information is provided from the cloud ID server.
